(19) United States
(12) Patent Application Publication
(10) Pub. No.: US 2012/0183866 A1
(43) Pub. Date: Jul. 19, 2012

(54) Fluorinated Arylboron Oxalate as Anion Receptors and Additives for Non-Aqueous Battery Electrolytes

(75) Inventors: Hung Sui Lee, Port Jefferson, NY (US); Xiao-Qing Yang, South Setauket, NY (US); Kyung-Wan Nam, Ridge, NY (US); Xiaojian Wang, Warren, MI (US)

(73) Assignee: Brookhaven Science Associates ,LLC, Upton, NY (US)

(21) Appl. No.: 13/388,017

(22) PCT Filed: Jul. 26, 2010
(86) PCT No.: PCT/US2010/043221

§ 371 Date: Apr. 6, 2012

Related U.S. Application Data
(60) Provisional application No. 61/229,390, filed on Jul. 29, 2009.

(51) Int. Cl. H01M 10/056; C07F 5/02

(52) U.S. Cl. 429/332; 429/200; 429/338; 429/342; 429/337; 429/343; 429/341; 562/882

(57) ABSTRACT

The present invention relates to electrochemical storage devices containing a non-aqueous lithium based electrolyte with high ionic conductivity, low impedance, and high thermal stability. More particularly, this invention relates to the design, synthesis and application of novel fluorinated arylboron oxalate based compounds which act as anion receptors and/or additives for non-aqueous batteries. When used as an anion receptor for non-aqueous battery electrolytes, the fluorinated arylboron oxalate enhances conductivity, lithium ion transference number and Solid Electrolyte Interface (SEI) formation capability during the formation cycling.

### CROSS-REFERENCE TO A RELATED APPLICATION

This application claims the benefit under 35 U.S.C. 119(e) of U.S. Provisional Application No. 61/229,390 filed on Jul. 29, 2009, the content of which is incorporated herein in its entirety.

### STATEMENT OF GOVERNMENT LICENSE RIGHTS

This invention was made with Government support under contract number DE-AC02-98CH10886, awarded by the U.S. Department of Energy. The Government has certain rights in the invention.

### BACKGROUND OF THE INVENTION

I. Field of the Invention

The present invention relates to electrochemical storage devices containing a non-aqueous lithium based electrolyte with high ionic conductivity, low impedance, and high thermal stability. More particularly, this invention relates to the design, synthesis and application of novel fluorinated arylboron oxalate based compounds which act as anion receptors and/or additives for non-aqueous batteries.

II. Background of the Related Art

The demand for lithium secondary batteries to meet high power and high-energy system applications has resulted in substantial research and development activities to improve their safety, as well as performance. As the world becomes increasingly dependent on portable electronic devices, and looks toward increased use of electrochemical storage devices for vehicles, power distribution load leveling and the like, it is increasingly important that three key objectives are met: performance, safety, and cost.

In recent years, extensive world-wide efforts have been undertaken to develop systems that meet such criteria. Nonetheless, all lithium salts, including commercially available salts, such as lithium hexafluorophosphate (LiPF₆), lithium tetrafluoroborate (LiBF₄), lithium trifluoromethanesulfonate (LiOSO₂CF₃), lithium bis(trifluoromethane-sulfonyl)imide (LiN(SO₂CF₃)₂), lithium bis(pentafluoroethanesulfonyl)imide (LiN(SO₂CF₂CF₃)₂), and salts under development, such as lithium bis(trifluoro-methane-sulfonyl)carbonade LiC(SO₂CF₃)₂, lithium tris(trifluoromethanesulfonyl)methide LiC(SO₂CF₃)₃, lithium bis(oxalate)borate (LiBOB), lithium tris(trifluoromethanesulfonyl)-trifluorophosphate LiPF₃(SO₂CF₃)₃) do not fully meet the above three requirements of cost, performance, and safety.

By way of example, most commercial lithium-ion batteries use electrolytes containing lithium hexafluorophosphate (LiPF₆). This salt has the necessary prerequisites for use in high-energy cells, i.e. it is easily soluble in aprotic solvents, it leads to electrolytes having high conductivities, and it has a high level of electrochemical stability. (Sloop, S E, et al. Electrochem. and Solid State Lett., 4, A42; (2001); incorporated herein by reference). LiPF₆, however, also has serious disadvantages, which are mainly to be attributed to its lack of thermal stability (Krause, L J., et al., Power Sources 68:320, (1997); incorporated herein by reference). In solution, LiPF₆ dissolves over time into LiF and PF₅, which can lead to a cationic polymerization of the solvent, caused by the Lewis acid PF₅. Upon contact with moisture, the caustic hydrofluoric acid (HF) is released, which, not only makes handling more difficult, because of its toxicity and corrosiveness, but also can lead to the (partial) dissolution of the transition-metal oxides (for example LiMn₂O₄) used as cathode material that can cause the capacity fading and the impedance increase during charge-discharge cycling. (J. S. Gnanaraj, E. Zinigrad, M. D. Levi, D. Aurbach, M. Schmidt, J. Power Sources 799 (2003) 119-121, incorporated herein by reference).

Other commercially-available salts are also problematic. For example, LiBF₄ exhibits poor solubility and may be contaminated with hydrofluoric acid. Both LiOSO₂CF₃ and LiN(SO₂CF₃)₂ are highly corrosive to aluminum substrates at potentials above 2.79 V and 3.67 V respectively. Lithium methide, LiC(SO₂CF₃)₃, (U.S. Pat. No. 5,273,840; incorporated herein by reference) is presently under development, but the price of its production may be an obstacle for consumer applications.

One solution has been proposed to overcome the limitations of liquid non-aqueous electrolytes is to include additives in order to enhance the electrochemical performance and the safety of the electrolytes. Even just a small amount of some of these additives can play an important role in forming stable solid electrolyte interphase (SEI) layer (Y. Wang, et al., J. Am. Chem. Soc. 124 (2002) 4408; G. H. Wrodnigg, et al., J. Electrochem. Soc. 146 (1999) 470, incorporated herein by reference), preventing overcharge phenomena (M. N. Golovin, et al., J. Electrochem. Soc. 139 (1992) 5; M. Adachi, et al., J. Electrochem. Soc. 146 (1999) 1256, incorporated herein by reference), or increasing flame retardant property (H. Ota, et al., J. Power Sources 119-121 (2003) 393; X. Wang, et al., J. Electrochem. Soc. 148 (2001) A1058, incorporated herein by reference). Also since all of the organic solvents for lithium batteries are Lewis bases and as a result, they only accommodate cations, recently, researchers have investigated anion receptors as a new additive for lithium secondary battery electrolytes (H. S. Lee, et al., J. Electrochem. Soc. 145 (1998) 2813; H. S. Lee, et al., J. Electrochem. Soc. 149 (2002) A1460; X. Sun, et al., J. Electrochem. Soc. 149 (2002) A355; X. Sun, et al., Electrochem. Solid-State Lett. 5 (2002) A248; M. Herstedt, et al., Electrochem. Commun. 5 (2003) 467; X. Sun, et al., Electrochem. Solid-State Lett. 6 (2003) A43, all incorporated herein by reference).

Anion receptors can form complexes with anions, and thereby inhibit the decomposition reaction of anions. They can also be used to increase both lithium-ion transference number and dissociation fraction of lithium salt. The fluorinated boron-based anion receptors (BBAR) are so acidic that some of these compounds even have the ability to promote dissolution of LiF, which is normally insoluble in organic solvents (H. S. Lee, et al., J. Electrochem. Soc. 145 (1998) 2813; H. S. Lee, et al., J. Electrochem. Soc. 149 (2002) A1460; X. Sun, et al., J. Electrochem. Soc. 149 (2002) A355, incorporated herein by reference). For example, the thermal stability of lithium ion cells with commercial liquid electrolyte was improved by using tris(pentafluorophenyl)borane (TPFPB) (Formula 1) as an anion receptor (X. Sun, et al., Electrochem. Solid-State Lett. 5 (2002) A248; M. Herstedt, et al., Electrochem. Commun. 5 (2003) 467; X. Sun, et al., Electrochem. Solid-State Lett. 6 (2003) A43, incorporated herein by reference),

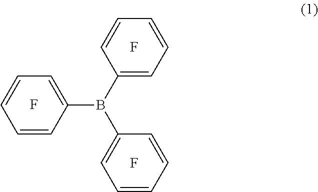

that can be used in conjunction with LiF (or Li₂O or Li₂O₂) salts. (L. F. Li, et al., Journal of Power Sources, 184(2), (2008), 517-521, incorporated herein by reference). It was found that the electrolytes using BBAR and LiF in non-aqueous solvents show quite impressive ionic conductivity, lithium ion transference numbers, and electrochemical stabilities (B. Xie, et al., Electrochem. Comm. 10 (2008) 1195, incorporated herein by reference). Recently, it was reported that TPFPB is also able to promote the dissolution of Li₂O and Li₂O₂ in organic carbonate solvents at room temperature, id., with the transference numbers for lithium ions as high as 0.6-0.8, similar to the values in the BBAR-LiF system (L. F. Li, et al., Journal of Power Sources, 184(2), (2008), 517-521, incorporated herein by reference). These values are more than two times higher than the 0.2-0.3 values for the conventional LiPF₆ based electrolytes. In addition, these electrolytes show high oxidation stability up to 5.0V vs Li/Li+ and good compatibility with bench-marked cathodes, i.e., LiCoO₂, LiMn₂O₄ and LiFePO₄.

Unfortunately, when used alone without other additives, the BBARs have poor ability to facilitate the formation of an SEI layer on the graphite surface, id., formed by deposition of the decomposed products of electrolyte solvents and salts such as Li₂CO₃, lithium alkyl carbonate, lithium alkyloxide, and other salt moieties (Ein-Eli, Y et al. J. Electrochem. Soc. 144 (1997) L180; Aurbach, D. et al. Electrochem. Soc. 142 (1995) 1746; incorporated herein by reference.) It has been shown that the SEI formed before the intercalation of Li⁺ ions is unstable and abundant with inorganic compounds. Furthermore, the SEI formed before the intercalation of Li⁺ ions produces more gaseous products, especially for PC-containing electrolytes. In the similar manner as surface modification, the SEI formation can be facilitated by chemically coating an organic film onto the surface of graphite through an electrochemical reduction of additives or the ability of additives to either scavenge radical anions, an intermediate compound of the solvent reduction or combine with the final products such as lithium alkyl dicarbonate and lithium alkyloxide to form more stable SEI components.

Boron-based compounds have been extensively studied as the electrolyte additive(s) that help increase the cycle life of Li-ion batteries, in which their function is believed to stabilize the resulting SEI. These compounds include inorganic B₂O₃ (U.S. Pat. No. 5,964,902 (1999), incorporated herein by reference), organic borates with undisclosed structure (M. Contestabile, et al., J. Power Sources 119-121 (2003) 943, incorporated herein by reference), boroxine family compounds such as trimethoxyboroxine and trimethylboroxin (U.S. Pat. No. 5,891,592 (1999), incorporated herein by reference), and lithium salt-based boron compounds (U.S. Pat. No. 6,548,212 (2003), incorporated herein by reference). These compounds were found not only to reduce capacity fading rate but also to increase rate capability and low temperature performance of the Li-ion batteries (M. Contestabile, et al., J. Power Sources 119-121 (2003) 943, incorporated herein by reference). Spectroscopic analyses on the electrode surface by FTIR and XPS revealed that the effect of these additives on the electrodes' performance was attributed to their incorporation to the surface chemistry of electrode (D. Aurbach, et al., J. Electrochem. Soc. 151 (2004) A23, incorporated herein by reference).

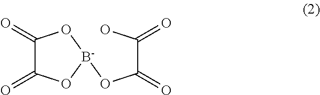

Lithium bis(oxalato)borate (LiBOB, 2) was initially studied as an alternative salt to improve the high temperature performance of Li-ion batteries (K. Xu, et al., Electrochem. Solid State Lett. 5 (2002) A26, incorporated herein by reference). It was shown that this salt not only is capable of suppressing the propylene carbonate (PC) irreversible reduction, but also significantly stabilizes the SEI against the extended cycling (K. Xu, et al., Electrochem. Solid-State Lett. 5 (2002) A259, incorporated herein by reference). Analyses of FTIR (G. V. Zhuang, et al., Electrochem. Solid-State Lett. 7 (2004) A224, incorporated herein by reference) and XPS (K. Xu, et al., Electrochem. Solid-State Lett. 6 (2003) A144, incorporated herein by reference) verify that B—O-based molecular moieties are clearly present in the SEI formed in LiBOB-based electrolytes. Based on this fact, it was proposed that LiBOB reacts with the major SEI components such as lithium alkyl dicarbonate and lithium alkoxide to form a more stable oligomer (3), where R presents the molecular moieties of the reduced products of the electrolyte solvents (S. S. Zhang, et al, J. Power Sources 129 (2004) 275, incorporated herein by reference).

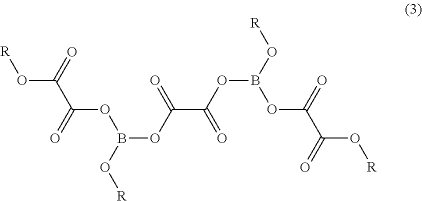

According to the chemistry of LiBOB and the final product, the formation of compound (3) may not involve any electronic transference, instead of a series of complicated exchange reactions between B—O and R—O bonds (S. S. Zhang, et al., J. Power Sources 156 (2006) 629, incorporated herein by reference). Further study revealed that LiBOB still retained its strong ability to facilitate SEI formation even its content in the electrolyte was reduced to an additive level (S. S. Zhang, Electrochem. Commun. 8 (2006) 1423, incorporated herein by reference). For example, the addition of 1 mol. % LiBOB is high enough to enable graphite cycling reversibly in a 1M LiPF₆ 1:1 (wt.) PC-EC electrolyte (U.S. patent application Ser. No. 10/625,686 (2003), incorporated herein by reference) and a 1M LiBF₄ electrolyte with the same solvent (S. S. Zhang, et al., J. Power Sources 156 (2006) 629, incorporated herein by reference), respectively. Another salt is lithium oxaltodifluoroborate (LiODFB) (U.S. patent application Ser. No. 10/625,686 (2003), incorporated herein by reference), which has the similar function to stabilize the SEI as LiBOB does, but it is superior to LiBOB in many other properties such as the solubility in carbonate solvents and the ability to provide better rate capability and low temperature performance of Li-ion batteries (S. S. Zhang, Electrochem. Commun. 8 (2006) 1423, incorporated herein by reference).

### SUMMARY OF THE INVENTION

Having recognized that the conventional anion receptors, such as BBARs, must be used with other additives to have an ability to facilitate the formation of an SEI layer on the graphite surfaces, the inventors determined that there is a need to design and synthesize a single boron compound that can act as both a boron based anion receptor (BBAR) and as an additive in non-aqueous battery electrolytes that can promote the dissolution of LiF, Li₂O and Li₂O₂ salts in non-aqueous solvents, while maintaining excellent conductivity, high lithium ion transference number, and superior SEI formation capability.

In one embodiment, this is accomplished by a single boron based anion receptor/additive represented by the formula (4), i.e., fluorinated arylboron oxalate (FABO):

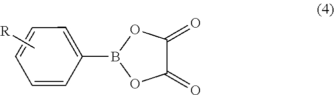

where R is a fluorine bearing moiety(ies). A non-limiting example of the fluorine bearing moiety is a fluorine, fluoromethyl, difluoromethyl, trifluoromethyl, 1-fluoro ethyl, 1,1-difluoroethyl, 1,1,2-trifluoroethyl, 1,1,2,2-tetrafluoroethyl, pentafluoroethyl, or any other fluorinated/nonfluorinated alkyl having from 1 to 6 carbon atoms, which may be linear or branched.

In another embodiment, the FABO is pentafluorophenylboron oxalate, 2,4-difluorophenylboron oxalate, 2,5-difluorophenylboron oxalate, 2,3,6-trifluorophenylboron oxalate, or 3,5-bis(trifluoromethyl)phenylboron oxalate.

In yet another embodiment, the non-aqueous electrolyte includes a lithium salt(s), a solvent(s), the anion receptor/additive of present invention and optionally other additives/anion receptors that may be used to prevent or to reduce gas generation of the electrolytic solution as the battery is charged and discharged at temperatures higher than ambient temperature, and/or to prevent overcharge or overdischarge of the battery. The additives may be further used to improve SEI formation capabilities, cathode protection, salt stabilization, safety protection, Li deposition improvement, solvation enhancement, corrosion inhibition and wetting.

In one embodiment, the invention is directed to electrochemical cells and batteries, particularly lithium rechargeable batteries, which include an anode, a cathode and non-aqueous electrolytes containing the anion receptor/additive of the present invention, i.e., FABO, that exhibit one or more of the improved properties such as better conductivity, higher lithium ion transference, superior SEI formation capability, electrochemical stability, reduced moisture sensitivity, improved lithium salt dissolution and enhanced thermal stability.

In a preferred embodiment, the electrochemical cell includes a graphite anode, a lithium mixed metal oxide (LiMMO) cathode and non-aqueous electrolyte that contains lithium salt(s), aprotic solvent(s), an anion receptor/additive of present invention, i.e., FABO, and optionally other additives.

In another preferred embodiment, the lithium salt is LiF, Li₂O, and/or Li₂O₂ in a binary mixed solvent made from ethylene carbonate (EC) or propylene carbonate (PC) and dimethyl carbonate (DMC), i.e., EC/DMC or PC/DMC.

In yet another preferred embodiment, the lithium salt is LiPF₆ and/or LiBF₄ in a binary mixed solvent made from PC/DMC, where FABO helps to suppress the intercalation of PC in the graphite anode due to its unique molecular design, i.e., the electron withdrawing group (fluorinatedphenyl) on one side of the boron and the oxalate group on the other side of the boron.

However, the compositions of the cathode, the anode and the electrolyte are not limited to compositions of the preferred embodiment and may comprise any compositions made apparent from the following detailed description, which is to be read in conjunction with the accompanying drawings. The scope of the invention will be pointed out in the claims.

### BRIEF DESCRIPTION OF THE DRAWINGS

FIG. 1 illustrates the chemical structure for several examples of fluorinated arylboron oxalate of the present invention.

FIG. 2 illustrates TG-DSC curve for pentafluorophenylboron oxalate (PFPOB) at heating rate of 5 C/min. The thermal decomposition of PFPOB starts at 180° C. and the final weight loss (87.2%) occurs near 500° C.

FIG. 3 illustrates a first and second cycle voltammograms (Current (A) vs. Potential (V vs. Li/Li⁺) of copper (Cu) electrode in composite electrolyte containing 0.5M LiF and 0.5 M PFPOB dissolved in PC/DMC (1:1, v/v). The reductive reaction of the LiF/PFPOB with Cu electrode is similar to the LiBOB electrolyte.

FIG. 4 illustrates a first and second cycle voltammograms (Current (A) vs. Potential (V vs. Li/Li⁺) of aluminum (Al) electrode in composite electrolyte containing 0.5M LiF and 0.5 M PFPOB dissolved in PC/DMC (1:1, v/v). The electrochemical passivation starts at about 3.6 V at the first scan and stable up to about 5.5 V at the second scan.

FIG. 5 illustrates temperature-dependant conductivities of different electrolytes. The different electrolytes show two slopes due to the liquid-solid phase transition below 0° C. The conductivity comparisons of different electrolytes at several temperatures are listed in Table 1.

FIG. 6A illustrates charge/discharge curves of Li/LiMn₂O₄ cells in a composite electrolyte containing 0.5 M PFPOB and 0.5 M LiF in PC/DMC (1:1, v/v) between 3.3 and 4.3 V at 25° C. at 0.1 C rate.

FIG. 6B illustrates charge/discharge curves of Li/LiMn₂O₄ cells in a composite electrolyte containing 0.5 M PFPOB and 0.25 M Li₂O in PC/DMC (1:1, v/v) between 3.3 and 4.3 V at 25° C. at 0.1 C rate.

FIG. 6C illustrates charge/discharge curves of Li/LiMn₂O₄ cells in a composite electrolyte containing 0.5 M PFPOB and 0.25 M Li₂O₂ in PC/DMC (1:1, v/v) between 3.3 and 4.3 V at 25° C. at 0.1 C rate.

FIG. 7 illustrates capacity cycle life behavior (capacity vs. cycle life) for Li/LiMn₂O₄ cell in a composite electrolyte containing 0.5 M PFPOB and 0.5 M LiF in PC/DMC (1:1, v/v) between 3.3 and 4.3 V at 25° C. at 0.1 C rate. The capacity maintenance is remarkably good.

FIG. 8A illustrates charge/discharge curves of Li/MCMB cell in a composite electrolyte containing 0.5 M PFPOB and 0.5 M LiF in PC/DMC (1:1, v/v) at 25° C.

FIG. 8B illustrates charge/discharge curves of Li/MCMB cell in a composite electrolyte containing 0.5 M PFPOB and 0.25 M Li₂O in PC/DMC (1:1, v/v) at 25° C.

FIG. 8C illustrates charge/discharge curves of Li/MCMB cell in a composite electrolyte containing 0.5 M PFPOB and 0.25 M Li₂O₂ in PC/DMC (1:1, v/v) at 25° C.

FIG. 9A illustrates the charge/discharge of Li/MCMB cells in a composite electrolyte containing 0.05 M PFPOB and 1 M LiBF₄ in PC/DMC (1:1, v/v) at 25° C. The system is not chargeable.

FIG. 9B illustrates the charge/discharge of Li/MCMB cells in a composite electrolyte containing 0.1 M PFPOB and 1 M LiBF₄ in PC/DMC (1:1, v/v) at 25° C. The system is not chargeable.

FIG. 9C illustrates the charge/discharge of Li/MCMB cells in a composite electrolyte containing 0.2 M PFPOB and 1 M LiBF₄ in PC/DMC (1:1, v/v) at 25° C. The system is not chargeable.

FIG. 9D illustrates the charge/discharge of Li/MCMB cells in a composite electrolyte containing 0.5 M PFPOB and 1 M LiBF₄ in PC/DMC (1:1, v/v) at 25° C. The system is chargeable, which means at least about 0.5M PFPOB is necessary to form SEI layer in 1 M LiFB₄ salt in PC/DMC.

FIG. 9E illustrates the charge/discharge of Li/MCMB cells in a composite electrolyte containing 0.05 M PFPOB, 0.05M LiF and 1 M LiBF₄ in PC/DMC (1:1, v/v) at 25° C. The system is not chargeable.

FIG. 10A illustrates the charge/discharge of Li/MCMB cells in a composite electrolyte containing 1 M LiPF₆ in PC/DMC (1:1, v/v) at 25° C. The data shows that without PFPOB, the system is not chargeable

FIG. 10B illustrates the charge/discharge of Li/MCMB cells in a composite electrolyte containing 0.05 M PFPOB and 1 M LiPF₆ in PC/DMC (1:1, v/v) at 25° C.

FIG. 10C illustrates the charge/discharge of Li/MCMB cells in a composite electrolyte containing 0.1 M PFPOB and 1 M LiPF₆ in PC/DMC (1:1, v/v) at 25° C.

FIG. 11A illustrates the charge/discharge of Li/MCMB cells in a composite electrolyte containing 0.05 M PFPOB and 1 M LiPF₆ in PC/DMC (1:1, v/v) at 25° C. The data shows that the cell cycled well and achieved an initial efficiency of 87.3% with the reversible capacity of about 300 mAh/g. Subsequent cycling raised the efficiency to (2) 96.6%, (3) 97.4%, (4) 97.7%, and (5) 98.0%.

FIG. 11B illustrates the charge/discharge of Li/MCMB cells in a composite electrolyte containing 0.1 M PFPOB and 1 M LiPF₆ in PC/DMC (1:1, v/v) at 25° C. The data shows that the cell cycled well and achieved an initial efficiency of 81.7% with the reversible capacity of about 300 mAh/g. Subsequent cycling raised the efficiency to (2) 94%, (3) 93.1%, (4) 93.5%, and (5) 93.8%.

### DETAILED DESCRIPTION OF THE INVENTION

The present invention is based on the discovery of novel single boron compounds that can act as an anion receptor and an additive of general formula (4):

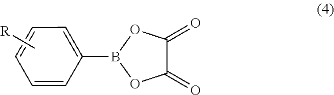

where R is a fluorine bearing moiety(ies). A non-limiting example of the fluorine bearing moiety is a fluorine, fluoromethyl, difluoromethyl, trifluoromethyl, 1-fluoro ethyl, 1,1-difluoroethyl, 1,1,2-trifluoroethyl, 1,1,2,2-tetrafluoroethyl, pentafluoroethyl, or any other fluorinated/nonfluorinated alkyl having from 1 to 6 carbon atoms, which may be linear or branched.

The anion receptor/additive of the present invention may be used in the electrolytic solution of lithium based non-aqueous electrochemical cells (batteries) that have an anode, a cathode and an electrolytic solution. The major components, electrolytic salts, solvents, anode and cathode are each described below in turn.

The other objectives of the invention will become more apparent from the following description and illustrative embodiments which are described in detail with reference to the accompanying drawings.

### I. Electrolytic Salt

The electrolytic salts are ionic salts containing at least one metal ion. Typically this metal ion is lithium (Li⁺). The electrolytic salts function to transfer charge between the anode and the cathode of a battery. The lithium salts of the present invention include salts of chelated orthoborates, chelated orthophosphates, perhalogenated and peroxidated lithium salts. The ortho-salts salts that may be used in the instant invention are, for example, lithium bis(oxalo)borate (LiBOB), lithium bis(malonato)borate (LiBMB), lithium bis(difluoromalonato)borate (LiBDFMB), lithium (malonato oxalato)borate (LiMOB), lithium (difluoromalonato oxalato)borate (LiDFMOB), lithium tris(oxalato)phosphate (LiTOP), and lithium tris (difluoromalonato)phosphate (LiTDFMP). The perhalogenated or peroxidated lithium salts that may be used in the present invention are, for example, LiF, Li₂O, Li₂O₂, LiPF₆, LiBF₄, LiClO₄, LiAsF₆, LiTaF₆, LiAlCl₄, Li₂B₁₀Cl₁₀, and LiCF₃SO₃. Any combination of two or more of the aforementioned salts may also be used. Preferably, the lithium salt is LiF, Li₂O, Li₂O₂, LiPF₆ and/or LiBF₄

The concentration of the lithium salt(s) in the electrolytic solution can be in the range of about 0.01-2.5 M (moles per liter). Preferably the concentration is 0.05 M to 2.0 M, and more preferably 0.1-1.0 M. In one embodiment the concentration of salt is 0.5 M. In another embodiment the concentration of salt is 1.0 M.

II. Solvent

A solvent useful in the present invention is a non-aqueous, aprotic, polar organic substance which dissolves the solute. Blends of more than one solvent may be used. Generally, solvents may be carbonates, carboxylates, lactones, phosphates, five or six member heterocyclic ring compounds, and organic compounds having at least one C₁-C₄ group connected through an oxygen atom to a carbon. Lactones may be methylated, ethylated and/or propylated. Generally, the electrolytic solution comprises at least one solute dissolved in at least one solvent. Useful solvents that can be made for the present invention include ethylene carbonate (EC), propylene carbonate (PC), butylene carbonate (BC), dimethyl carbonate (DMC), diethyl carbonate (DEC), dipropyl carbonate (DPC), dibutyl carbonate (DBC), ethyl methyl carbonate (EMC), methyl propyl carbonate (MPC), ethyl propyl carbonate (EPC), tetrahydrofuran, 2methyl tetrahydrofuran, 1,3-dioxolane, 1,4-dioxane, 1,2-dimethoxyethane, 1,2-diethoxyethane, 1,2-dibutoxyethane, acetonitrile, dimethylformamide, methyl formate, ethyl formate, propyl formate, butyl formate, methyl acetate, ethyl acetate, propyl acetate, butyl acetate, methyl propionate, ethyl propionate, propyl propionate, butyl propionate, methyl butyrate, ethyl butyrate, propyl butyrate, butyl butyrate, γ-butyrolactone, 2-methyl-γ-butyrolactone, 3-methyl-γ-butyrolactone, 4-methyl-γ-butyrolactone, β-propiolactone, δ-valerolactone, trimethyl phosphate, triethyl phosphate, tris(2-chloroethyl)phosphate, tris(2,2,2-trifluoroethyl) phosphate, tripropyl phosphate, triisopropyl phosphate, tributyl phosphate, trihexyl phosphate, triphenyl phosphate, tritolyl phosphate, and combinations thereof. Other solvents may be used so long as they are non-aqueous and aprotic, and are capable of dissolving the solute salts.

In a preferred embodiment, the solvent is made from one or more carbonates selected from ethylene carbonate (EC), propylene carbonate (PC), butylene carbonate (BC), dimethyl carbonate (DMC), diethyl carbonate (DEC), dipropyl carbonate (DPC), dibutyl carbonate (DBC), ethyl methyl carbonate (EMC), methyl propyl carbonate (MPC), ethyl propyl carbonate (EPC). Preferably, the solvent is a binary mixture of two carbonates, however, other mixtures are also envisioned such as between carbonates and non-carbonates, ternary mixtures and other combinations so long as they are non-aqueous and aprotic, and are capable of dissolving the solute salts.

Preferably, the solvent comprises a binary mixed organic solvents containing a 1:1 volume ratio of EC/DMC, PC/DMC, EC/PC, EC/DMC, PC/DMC, and PC/DME or a ternary mixed organic solvent containing a 1:1:1 volume ratio of EC/DMC/DEC. More preferably, the organic solvent is a binary mixed EC/DMC or PC/DMC at 1:1 volume ratio.

III. Anode

The anode may comprise carbon or lithium based alloys. The carbon may be in the form of graphite such as, for example, mesophase carbon microbeads (MCMB). Lithium metal anodes may be lithium mixed metal oxide (MMOs) such as LiMnO₂ and Li₄Ti₅O₁₂. Alloys of lithium with transition or other metals (including metalloids) may be used, including LiAl, LiZn, Li₃Bi, Li₃Cd, Li₃Sd, Li₄Si, Li_{4.4}Pb, Li_{4.4}Sn, LiC₆, Li₃FeN₂, Li_{2.6}Co_{0.4}N, Li_{2.6}Cu_{0.4}N, and combinations thereof. The anode may further comprise an additional material such as a metal oxide including SnO, SnO₂, GeO, GeO₂, In₂O, In₂O₃, PbO, PbO₂, Pb₂O₃, Pb₃O₄, Ag₂O, AgO, Ag₂O₃, Sb₂O₃, Sb₂O₄, Sb₂O₅, SiO, ZnO, CoO, NiO, FeO, and combinations thereof.

The anode may further comprise a polymeric binder. In a preferred embodiment, the binder may be polyvinylidene fluoride, styrene-butadiene rubber, polyamide or melamine resin, and combinations thereof.

IV. Cathode

The cathode may comprise a lithium metal oxide compound. In particular, the cathode may comprise at least one lithium mixed metal oxide (Li-MMO). Lithium mixed metal oxides contain at least one other metal selected from the group consisting of Mn, Co, Cr, Fe, Ni, V, and combinations thereof. For example the following lithium MMOs may be used in the cathode: LiMnO₂, LiMn₂O₄, LiCoO₂, Li₂Cr₂O₇, Li₂CrO₄, LiNiO₂, LiFeO₂, LiNiₓCo₁₋ₓO₂ (O<x<1), LiFePO₄, LiMn_{z}Ni_{1-z}O₂ (0<z<1), LiMn_{0.5}Ni_{0.5}O₂), LiMn_{0.33}Co_{0.33}Ni_{0.33}O₂, LiMc_{0.5}Mn_{1.5}O₄, where Mc is a divalent metal; and LiNiₓCo_{y}Me_{z}O₂ where Me may be one or more of Al, Mg, Ti, B, Ga, or Si and 0<x,y,z<1. Furthermore, transition metal oxides such as MnO₂ and V₂O₅; transition metal sulfides such as FeS₂, MoS₂ and TiS₂; and conducting polymers such as polyaniline and polypyrrole may be present. The preferred positive electrode material is the lithium transition metal oxide, including, especially, LiCoO₂, LiMn₂O₄, LiNi_{0.8}Co_{0.15}Al_{0.05}O₂, LiFePO₄, and LiNi_{0.33}Mn_{0.33}Co_{0.33}O₂. Mixtures of such oxides may also be used.

The cathode may further comprise a polymeric binder. In a preferred embodiment, the binder may be polyvinylidene fluoride, styrene-butadiene rubber, polyamide or melamine resin, and combinations thereof.

V. Anion Receptor/Additive

The electrolytic solution in the present invention further contains one or more anion receptors/additives that may generally be described as fluorinated arylboron oxalates (FABO) of formula (4):

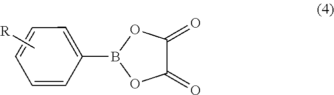

where R is a fluorine bearing moiety(ies). A non-limiting example of the fluorine bearing moiety is a fluorine, fluoromethyl, difluoromethyl, trifluoromethyl, 1-fluoro ethyl, 1,1-difluoroethyl, 1,1,2-trifluoroethyl, 1,1,2,2-tetrafluoroethyl, pentafluoroethyl, or any other fluorinated/nonfluorinated alkyl having from 1 to 6 carbon atoms, which may be linear or branched.

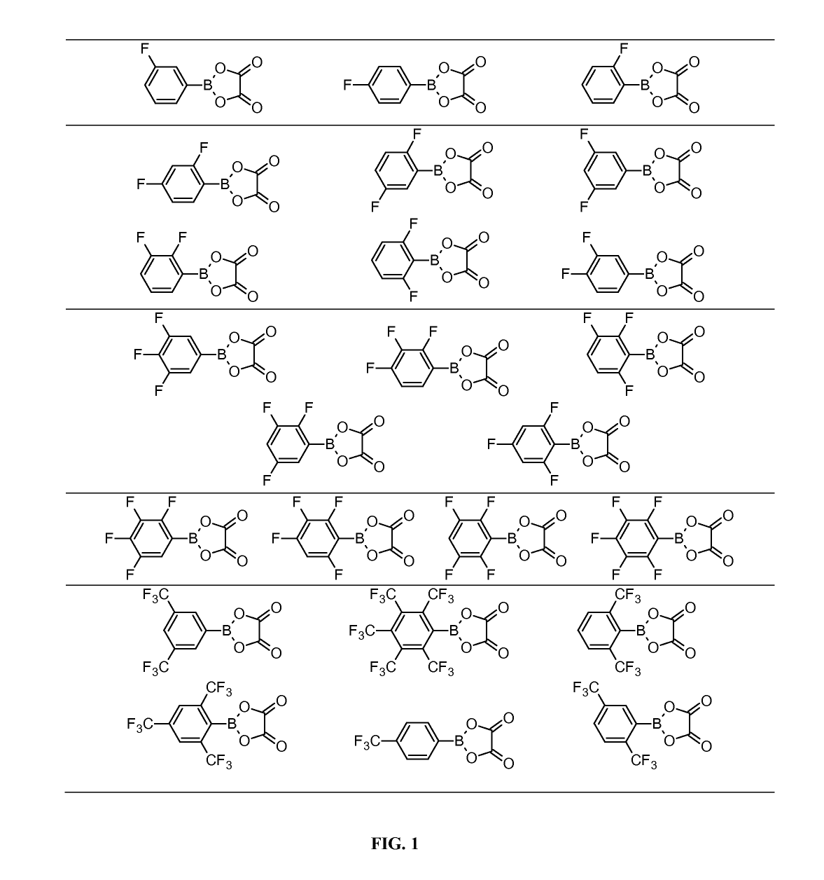

The non-limiting example of FABO is pentafluorophenylboron oxalate (PFPBO; 5), 2,4-difluorophenylboron oxalate (6), 2,5-difluorophenylboron oxalate (7), 2,3,6-trifluorophenylboron oxalate (8), and 3,5-bis(trifluoromethyl)phenylboron oxalate (9). The structures of these compounds are summarized in Table 1. Other examples of the FABOs are shown in FIG. 1.

TABLE 1
Representative non-limiting examples of FABO structures

| | |
|---|---|
| 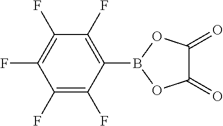 | (5) |
| 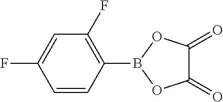 | (6) |
| 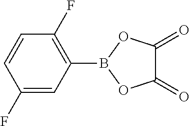 | (7) |
| 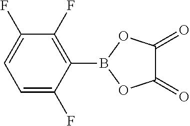 | (8) |
| 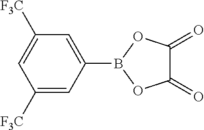 | (9) |

The preparation of the FABO of the present invention may be conveniently conducted in one relatively simple synthesis step:

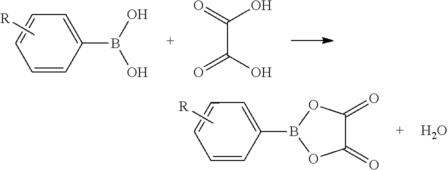

where R may be a fluorine bearing moiety or a combination of two or more fluorine bearing moieties. For instance, R may be a fluorine, fluoromethyl, difluoromethyl, trifluoromethyl, 1-fluoroethyl, 1,1-difluoroethyl, 1,1,2-trifluoroethyl, 1,1,2,2-tetrafluoroethyl, pentafluoroethyl, or any other fluorinated/nonfluorinated alkyl having from 1 to 6 carbon atoms, which may be linear or branched.

Synthesis: The fluorinated arylboronic acid used as a starting material may be purchased (e.g., Sigma Aldrich) or prepared following procedure described in Murphy J. M., Org Lett., 9, 757-760, (2007) incorporated herein by reference in its entirety. The arylboronic acid may be synthesized by Ir-catalyzed borylation of arenes followed by oxidative cleavage of the boronic ester with NaIO₄:

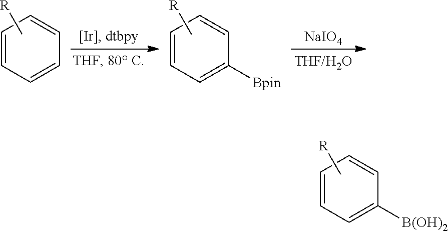

The fluorinated arylboron oxalate is prepared by mixing is a fluorinated phenylboronic acid and oxalic acid in benzene. The mixture is refluxed until the collected water in a Dean-Stark trap is reached the expected theoretical amount based on the amount of starting materials (e.g., about 2-3 hours). After cooling the solid product is collected by filtration. The solid product is treated with ether solvent. After filtering out the insoluble solid (which is boroxin), the ether solution was concentrated by evaporating the ether completely. Then benzene is added to the residue. After leaving the benzene solution in the refrigerator for an extended period (e.g., overnight or ˜12 hours), crystals of the product are isolated. The crystals are further filtered out and further washed using benzene. The synthesis of the FABO may be confirmed by ¹H or ¹⁹F NMR.

It is to be understood that the method of synthesizing FABO as described above is merely exemplary. Any of a plurality of alternative methods which are well-known in the art and which are capable of forming FABO with the desired purity may be employed.

The anion receptor/additive FABO may be used alone at concentrations of about 0.01-1.0 M (preferably at about 0.05-0.5M) or in combination with other anion receptors and/or additives that may improve the cycleability and cycle life of Li-ion batteries; facilitate formation of solid electrolyte interface/interphase (SEI) on the surface of graphite, reduce irreversible capacity and gas generation for the SEI formation and long-term cycling, enhance thermal stability of LiPF₆ against the organic electrolyte solvents, protect cathode material from dissolution and overcharge, improve physical properties of the electrolyte such as ionic conductivity, viscosity, wettability to the polyolefine separator, and so forth. For better battery safety, the additional additives may be able to lower flammability of organic electrolytes, provide overcharge protection or increase overcharge tolerance, and terminate battery operation in abuse conditions.

The additional additives useful in the present invention may be selected from (1) reduction-type additives, (2) reaction-type additives, (3) SEI morphology modifiers, (4) cathode protection agents, (5) LiPF6 salt stabilizers, (6) overcharge protectors, (7) fire-retardant additives, (8) Li deposition improvers, (9) ionic solvation enhancers, (10) Al corrosion inhibitors, (11) wetting agents, and (12) viscosity diluters. A review on electrolyte additives for lithium-ion batteries may be found in Zhang, S-S. Journal of Power Sources 162 (2006) 1379-1394, the content of which is incorporated herein by reference.

An example of additive useful in the present invention alone or in combination is vinylene carbonate (VC), vinyl ethylene carbonate, allyl ethyl carbonate, vinyl acetate, divinyl adipate, acrylic acid nitrile, 2-vinyl pyridine, maleic anhydride, methyl cinnamate, phosphonate, vinyl-containing silane-based compounds, furan derivatives that contain two double bonds in each molecule, SO₂, CS₂, polysulfide (Sₓ²⁻), cyclic alkyl sulfites such as ethylene sulfite and propylene sulfite, aryl sulfites, N₂O, nitrate, nitrite, halogenated ethylene carbonate, halogenated lactone such as a-bromo-y-butyrolactone, methyl chloroformate, the A series of carboxyl phenol, aromatic esters, anhydride, tris(2,2,2-trifluoroethyl), phosphite (TTFP), 1-methyl-2-pyrrolidinone, fluorinated carbamate, hexamethyl-phosphoramide, monomethoxy benzene class compound, hexaethyl benzene, bipyridyl or biphenyl carbonates, difluoroanisoles, thianthrene, 2,7-diacetyl thianthrene, phenothiazine based compounds, xylene, cyclohexylbenzene, biphenyl, 2,2-diphenylpropane, phenyl-tert-butyl carbonate, phenyl-R-phenyl compounds (R =aliphatic hydrocarbon, fluorine substituted), 3-thiopheneacetonitrile, tetraalkylammonium chlorides with a long alkyl chain, cetyltrimethylammonium chlorides, lithium and tetraethylammonium salts of perfluorooctanesulfonate, perfluoropolyethers, borate, borane, borole and other compounds so long as they provide benefits (1)-(12) listed above.

### VI. Electrochemical Cell

As with most batteries, the lithium based non-aqueous electrochemical cell has an outer case made of metal or other material(s) or composite(s). For example, this case holds a long spiral comprising three thin sheets pressed together:

(1) A positive electrode (cathode);

(2) A negative electrode (anode); and

(3) A separator

The separator is a very thin sheet of microperforated plastic, however, other materials may be used in the present invention to separate the positive and negative electrodes while allowing ions to pass through. The cathode is generally made of metal oxide, such as lithium cobalt oxide. The anode is generally made of carbon. Both the anode and cathode are materials into which and from which lithium can migrate. When the battery charges, ions of lithium move through the electrolyte from the positive electrode to the negative electrode and attach to the carbon. During discharge, the lithium ions move back to the cathode from the anode. Inside the case these sheets are submerged in an organic solvent that acts as the electrolyte. The electrolyte is composed of one or more lithium salts, one or more solvents and one or more anion receptors/additives.

One aspect of the present invention is that the electrolyte consists at least of one FABO compound that facilitates one or more of the following properties of the electrolyte solution: (1) the formation of a stable Solid Electrolyte Interface (SEI) layer on the graphite surface of the anode during the formation cycling, (2) higher lithium ion transference, (3) electrochemical stability, (4) reduced moisture sensitivity, (5) improved lithium salt dissolution and (6) enhanced thermal stability.

Without being bound by the theory, it is anticipated that FABO is able to form complexes with anions, and thereby inhibit the decomposition reaction of anions. Also due to its acidic nature, FABO has the ability to promote dissolution of perhalogenated or peroxidated lithium salts such as LiF, Li₂O, or Li₂O₂, which are normally insoluble in organic solvents. Furthermore, it is anticipated that FABO may react with the major SEI components such as lithium alkyl dicarbonate and lithium alkoxide to form a more stable oligomers, which may suppress propylene carbonate (PC) co-intercalation and stabilize the SEI against the extended cycling.

Furthermore, without being bound by the theory, FABO can also be used as additives to enhance the SEI formation on the surface of anode for non-aqueous electrolytes using LiPF₆ and LiBF₄ salts in PC/DMC solvents to suppress the intercalation of PC. These superior properties were due to a unique molecular design of the structures of these compounds—the electron withdrawing group (fluorinatedphenyl) on one side of the boron and the oxalate group on the other side of the boron. These unique structures benefit from the anion complexing property of the boron based anion receptors such as tris(pentafluorophenyl) borane (TPFPB) and the SEI formation capability of the oxalates.

It is envisioned that the electrochemical cells (batteries) that include the electrolyte solution(s) of the present invention and in particular the anion receptors/additives of the present invention have a wide range of applications, including, but not limited to, calculators, wrist watches, hearing aids, electronics such as computers, cell phones, games etc, and transportation applications such as battery powered and/or hybrid vehicles.

While the lithium based electrochemical cell of the present invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

### EXAMPLES

The examples set forth below also serve to provide further appreciation of the invention but are not meant in any way to restrict the scope of the invention.

### Example 1

This example illustrates the synthesis of FABO compounds summarized in Table 1. The boronic acid employed as starting material was purchased from Sigma-Aldrich (St. Louis, Mo.) except for the 2,5-bis(trifluoromethyl)phenyboronic acid, which was synthesized following the procedure outlined in U.S. Pat. No. 6,022,643, incorporated herein by reference. All moisture sensitive reactions were carried out under argon.

A mixture of 0.05 M of arylboronic acid and 0.05 M of oxalic acid in 80 mL of benzene was refluxed until the collected water in a Dean-Stark trap was reached the expected theoretical amount based on the amount of starting materials (about 2-3 hours). After cooling the solid product was collected by filtration. The solid product was treated with ether solvent. After filtering out the insoluble solid (which is boroxin), the ether solution was concentrated by evaporation of ether. Then 20 mL of benzene was added to the residue. After leaving the benzene solution in the refrigerator for 12 hours, crystals of the product were isolated. The crystals were further filtered out and further washed using benzene.

TABLE 2
Physical properties and Yields of the fluorinated arylboron
oxalate compound

| | Boiling Point | Yield | ¹H-NMR |
|---|---|---|---|
| Compound | (° C.) | (%) | (Aceton-d₆ ppm) |
| pentafluorophenylboron | 248-250 | 52 | n/a |
| oxalate (5) | | | |
| 2,4-difluorophenylboron | 211-213 | 41 | δ, 6.6-7.2 (m) |
| oxalate (6) | | | |
| 2,5-difluoro-phenylboron | 201-202 | 31 | δ, 6.8-7.5 (m) |
| oxalate (7) | | | |
| 2,3,6-trifluorophenylboron | 203 | 43 | δ, 6.5-7.5 (m) |
| oxalate (8) | | | |
| 3,5-bis(trifluoromethyl)- | 195-197 | 45 | δ, 7.8-8.5 (m) |
| phenylboron oxalate (9) | | | |

### Example 2

This example illustrates the preparation of electrolytic solutions of perhalogenated or peroxidated lithium salts (e.g., LiF, Li₂O, Li₂O₂, LiPF₆, and LiBF₄) and fluorinated arylboron oxalates (e.g., compounds (5)-(9); Table 2), in non-aqueous solvents (e.g., PC/DMC, EC/DMC). In a dry glove box, 0.01-1.0 M of FABO was placed into a volumetric flask and the non-aqueous solvents or solvent mixtures was added. The mixture was shaken occasionally to allow all oxalate to dissolve. Then, 0.1-1.0 M of lithium salt was added into the mixture. The final mixture was shaken occasionally to allow all lithium salt to dissolve.

### Example 3

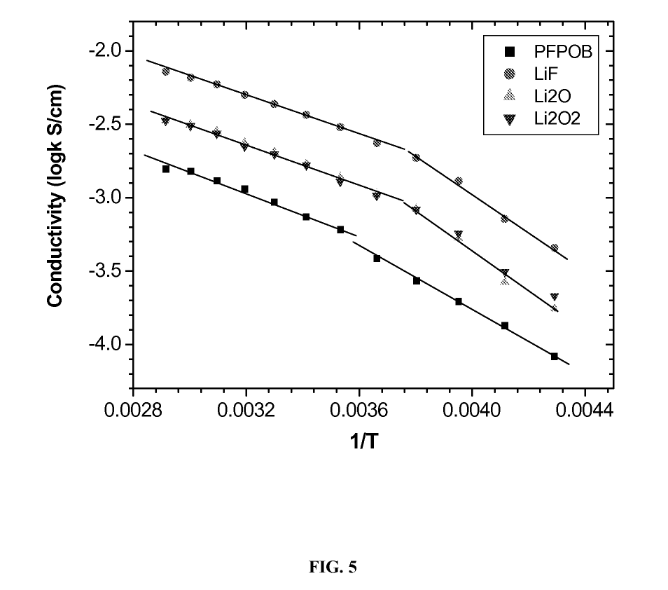

This example illustrates the conductivities of different electrolytes in a relative wide temperature range (see FIG. 5). FIG. 5 shows that all electrolytes have two slopes due to the liquid-solid phase transition below 0° C. and the activation energies for high temperature and low temperature are very similar.

PFPOB can solve LiF, Li2O and Li2O2, which means that this compound has the similar anion attracting effect as TPFPB BBAR.

### Example 4

This example illustrates the conductivity comparisons of different electrolytes illustrated in Table 2 at several temperatures. Conductivity measurements were performed using a Hewlett-Packard 4192A impedance analyzer in the frequency range from 5 Hz to 1 MHz. Cells with Pt electrodes were used for the conductivity measurements. The cell constant was determined using a standard 0.01M KCl aqueous solution in for every sample measured. The lithium ion transference number was obtained by combining AC impedance and DC polarization measurements using the same Li/electrolyte/Li cell. Specifically, the Li⁺ ion transference numbers were measured by combining AC impedance and DC polarization on the same cell containing same sample using two lithium foils as non-blocking electrodes. First, AC impedance was measured to obtain a total resistance Rₜₒₜₐₗ. Then a constant DC voltage V_{DC} (50-200 mV) was applied on the same cell. After polarization, a stable current h_{DC} was obtained. The DC resistance R_{DC}=V_{DC}/I_{DC}. The Li ion transference number t_{Li+}=Rₜₒₜₐₗ/R_{DC} can be calculated (the same cell constant is cancelled out through the calculation). This simplified evaluation of the transfer number is valid presuming that the IDC is caused by the transport of lithium ions only and the interphase resistance (SEI film) is negligible and the electrolyte is stable during polarization.

Table 3 shows that the 0.5M LiF-0.5M PFPOB-PC/DMC (1:1) electrolyte has excellent conductivity at room temperature and impressive conductivity at temperature as low as −30° C. This is comparable with data for 0.5 M LiF-0.5M TPFPB-PC/DMC (1:1). The table also shows that the Li ion transference number for every PFPOB based electrolyte is close to the transference number for TPFPB based electrolyte, while PFPOB/LiF is slightly lower. PFPOB/Li₂O or Li₂O₂ show higher values than TPFPB, indicating a stronger electron withdrawing effect by the fluorinated phenyl ring of the PFPOB in peroxyginated lithium salts. The higher Li ion transference number can improve effective Li ion conductivity (defined as total conductivity multiplies the Li ion transference number).

TABLE 3
Conductivity data for lithium fluoride salt in 1:1 volumatric ratio of
PC/DMC.

| | Conductivity | | | |
|---|---|---|---|---|
| Electrolyte | (mS/cm) | | | |
| (PC/DMC, 1:1) | −30 | 30 | 60 | t_{Li+} |
| 0.5M PFPOB/0.5M LiF | 0.7 | 4.4 | 6.6 | 0.58 |
| 0.5M PFPOB/0.5M Li₂O | 0.3 | 2.0 | 3.1 | 0.83 |
| 0.5M PFPOB/0.5M Li₂O₂ | 0.3 | 2.2 | 3.1 | 0.78 |
| 0.5M TPFPB/0.5M LiF | 0.8 | 4.3 | 6.1 | 0.71 |

### Example 5

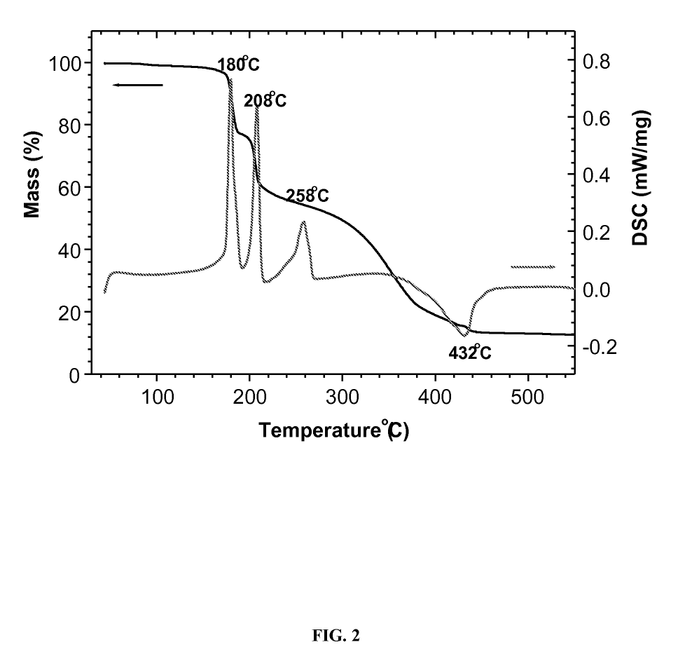

This example illustrates the thermal stability of PFPOB. The thermal stability of the electrolytes and anion receptors were determined using differential scanning calorimetry (DSC) analysis method by a NETSCH STA 449C. A sample of about 20 mg was sealed in an aluminum crucible in the glove box. A pinhole was punched on the crucible before DSC measurement. The crucible was first cooled down to −70° C. and then heated to 150° C. at a heating rate of 5° C/min for electrolytes and heated from 30 to 500° C. for PFPOB additive. FIG. 2 shows the TGA-DSC curves of the PFPOB (compound 5; Table 1). The thermal decomposition of PFPOB compound starts at 180° C. and the final weight loss when heated to 500° C. is 87.2%.

### Example 6

Electrochemical windows were studied by cyclic voltammogram technique using a three-electrode cell with a copper foil or aluminum foil as working electrode, one lithium metal foil as counter electrode and another lithium metal foil as reference electrode. The scanning rate was 0.25 mVs⁻¹ and the measurement was performed at room temperature. The electrolytic solution studied contained 0.5M LiF-0.5M PFPOB-PC/DMC (1:1).

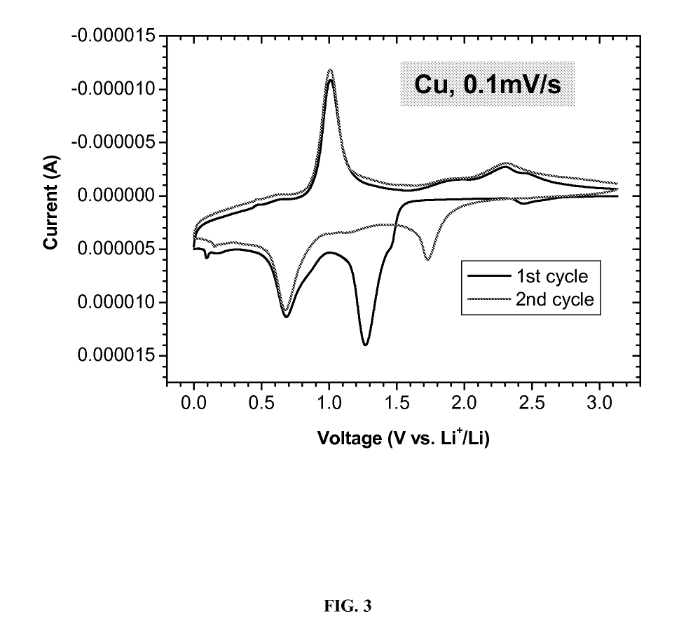

The electrochemical window of PFPOB was investigated in a wide potential range of 0-3.0 V versus Li/Li⁺ using a Cu foil as working electrode (see FIG. 3). The CV curve in FIG. 3 shows that the reductive reaction of the PFPOB/LiF electrolyte with copper electrode is similar to that of the LiBOB electrolyte.

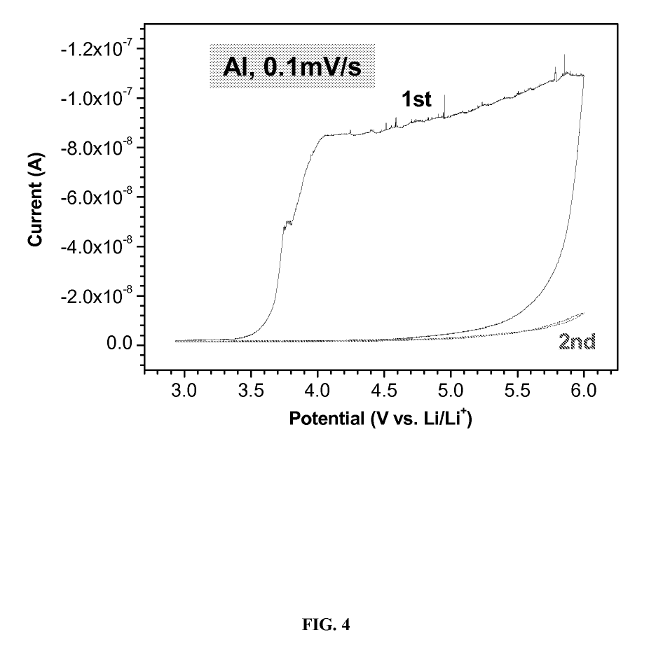

The electrochemical window of PFPOB was also investigated in a potential range of 3.0-6.0 V versus Li/Li⁺ using a Al foil as working electrode (see FIG. 4). The CV curve in FIG. 4 shows that a passivation starts at 3.6V of the first scan and can stabilize up to 5.5 V of the second scan.

### Example 7

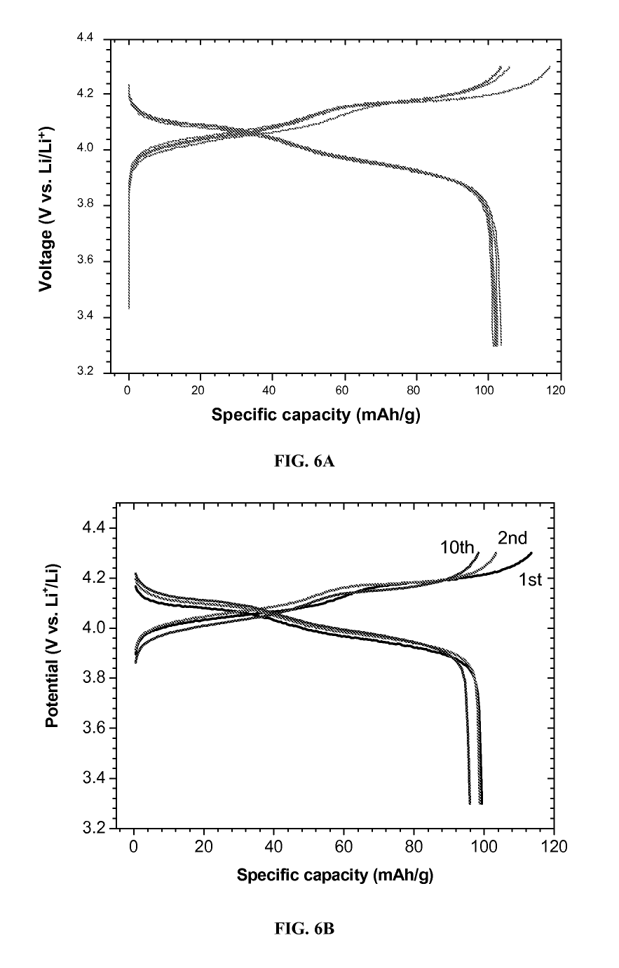

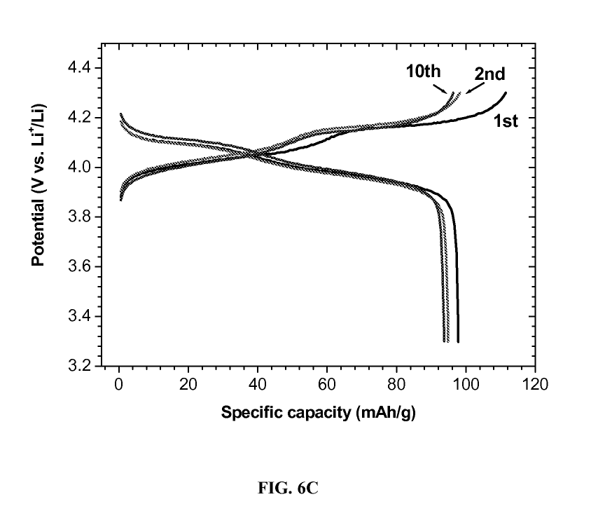

This example illustrates charge/discharge curves of Li/LiMn₂O₄ cells in a composite electrolyte containing (A) 0.5 M PFPOB and 0.5 M LiF in PC/DMC (1:1, v/v); (B) 0.5 M PFPOB and 0.25 M Li₂O in PC/DMC (1:1, v/v); and (C) 0.5 M PFPOB and 0.25 M Li₂O₂ in PC/DMC (1:1, v/v) between 3.3 and 4.3 V at 25° C. at 0.1 C rate. (see FIG. 6) The data shows good initial Coulomb efficiency at 85%. The reversible capacity is about 105 mAh/g. The Coulomb efficiency of LiMn₂O₄ cathode further increased to close to 100% during the second and third formation cycles, respectively.

### Example 8

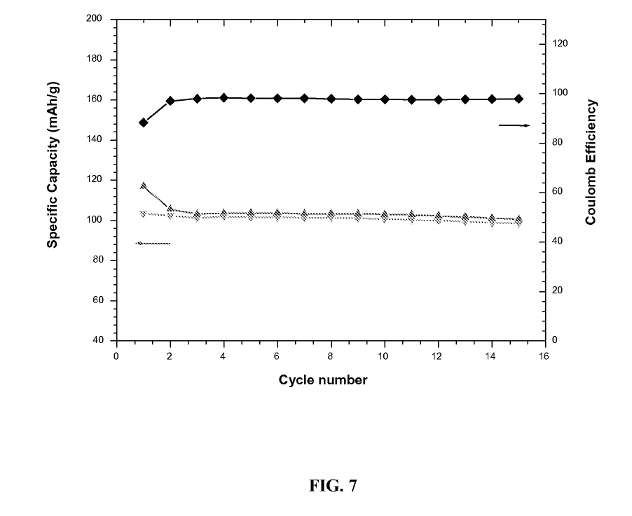

This example illustrates the capacity cycle life behavior (capacity vs. cycle life) for Li/LiMn₂O₄ cell in a composite electrolyte containing 0.5 M PFPOB and 0.5 M LiF in PC/DMC (1:1, v/v) between 3.3 and 4.3 V at 25° C. at 0.1 C rate. The capacity retention is very good. (see FIG. 7)

### Example 9

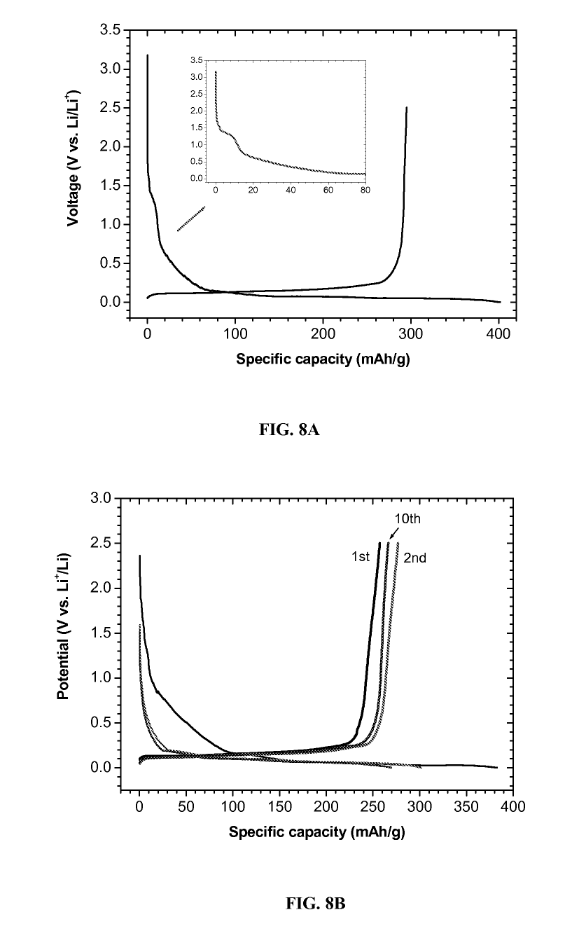

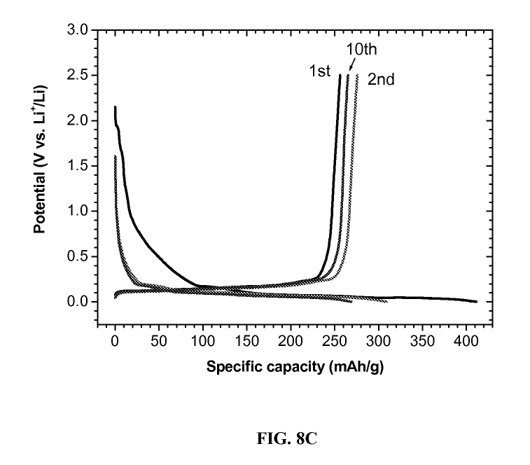

This example illustrates the charge/discharge of Li/MCMB cell in a composite electrolyte containing (A) 0.5 M PFPOB and 0.5 M LiF in PC/DMC (1:1, v/v); (B) 0.5 M PFPOB and 0.25 M Li₂O in PC/DMC (1:1, v/v); and (C) 0.5 M PFPOB and 0.25 M Li₂O₂ in PC/DMC (1:1, v/v) at 25° C. (see FIG. 8). Overall, the data indicates a good chargeability with a capacity close to 300 mAh/g.

### Example 10

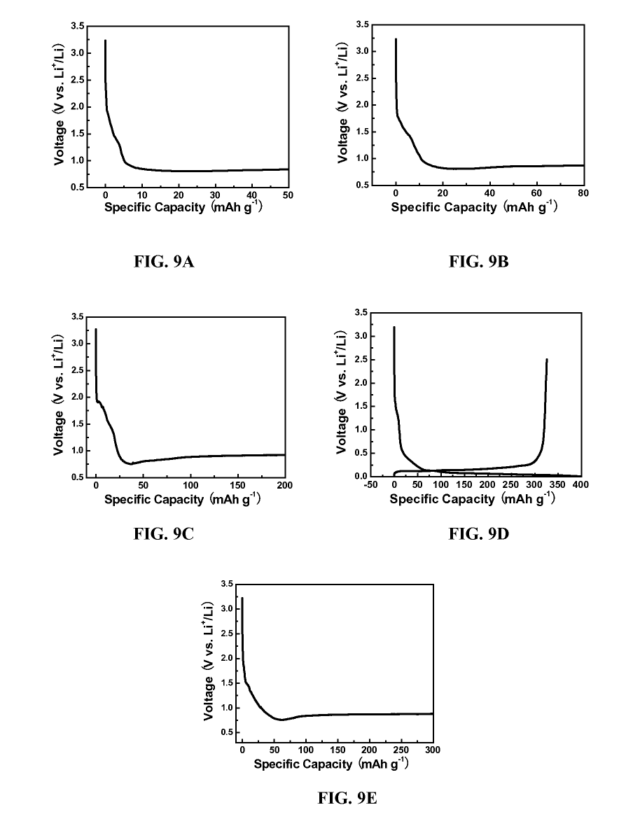

This example illustrates the charge/discharge of Li/MCMB cells in a composite electrolyte containing (A) 1 M LiBF₄ in PC/DMC (1:1, v/v), (B) 0.1 M PFPOB and 1 M LiBF₄ in PC/DMC (1:1, v/v); (C) 0.2 M PFPOB and 1 M LiBF₄ in PC/DMC (1:1, v/v); (D) 0.5 M PFPOB and 1 M LiBF₄ in PC/DMC (1:1, v/v); and (E) 0.05 M PFPOB, 0.05M LiF and 1 M LiBF₄ in PC/DMC (1:1, v/v) at 25° C. (see FIG. 9). The data shows that PFPOB can be used as an additive to form SEI layer in 1 M LiFB₄ salt in PC/DMC at concentrations of at least about 0.5 M.

### Example 11

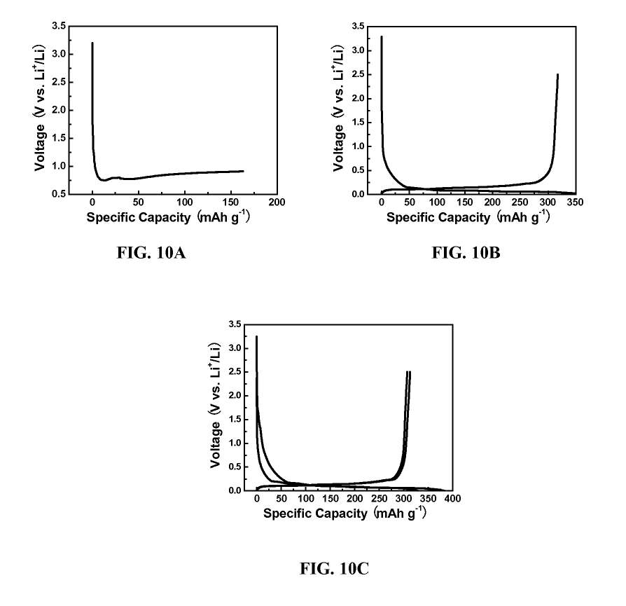

This example illustrates the charge/discharge of Li/MCMB cells in a composite electrolyte containing (A) 1 M LiPF₆ in PC/DMC (1:1, v/v), (B) 0.05 M PFPOB and 1 M LiPF₆ in PC/DMC (1:1, v/v); and (C) 0.1 M PFPOB and 1 M LiPF₆ in PC/DMC (1:1, v/v) at 25° C. (see FIG. 10) The data shows that PFPOB can be used as an additive to form SEI layer in 1 M LiPF₆ salt in PC/DMC at concentration as low as 0.05M.

### Example 12

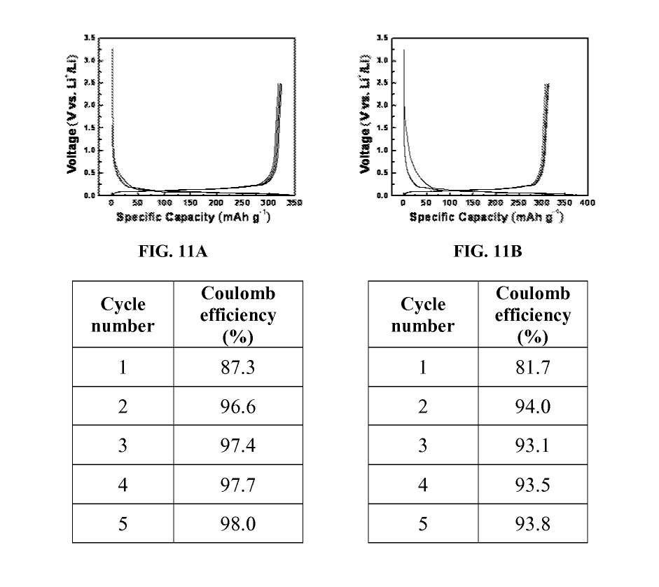

This example illustrates the charge/discharge of Li/MCMB cells in a composite electrolyte containing (A) 0.05 M PFPOB and 1 M LiPF₆ in PC/DMC (1:1, v/v); and (B) 0.1 M PFPOB and 1 M LiPF₆ in PC/DMC (1:1, v/v) at 25° C. (see FIG. 11). The data shows that the cell cycled well and achieved an initial efficiency of 87.3% and 81.7% with the reversible capacity about 300 mAh/g in either 0.05 M PFPOB or 0.1 M PFPOB, respectively. This is clear evidence for the stability of the SEI film on the MCMB anode in the first cycle.

The results further show that the Coulomb efficiency for the electrolyte with 0.05M of additive increased from 87.3% to 96.6% (2nd cycle), 97.4% (3rd cycle), 97.7% (4th cycle), and finally to 98.0% (5th cycle), indicating a stable SEI layer formation. The results further show that the Coulomb efficiency for the electrolyte with 0.1M of additive increased from 81.7% to 94.0% (2nd cycle), 93.1% (3rd cycle), 93.5% (4th cycle), and finally to 93.8% (5th cycle), indicating a stable SEI layer formation. The concentration as low as 0.05 M is sufficient to form stable SEI layer on MCMB. In contrast, for a reference electrolyte using LiBF₄ as conducting salt in PC/DMC (1:1 volume ratio), the Coulomb efficiency is almost zero during the formation cycling, caused by the lack of stable SEI layer formation.

It will be appreciated by persons skilled in the art that the present invention is not limited to what has been particularly shown and described hereinabove. Rather, the scope of the present invention is defined by the claims which follow. It should further be understood that the above description is only representative of illustrative examples of embodiments. For the reader's convenience, the above description has focused on a representative sample of possible embodiments, a sample that teaches the principles of the present invention. Other embodiments may result from a different combination of portions of different embodiments.

The description has not attempted to exhaustively enumerate all possible variations. The alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent. Furthermore, all references, publications, U.S. Patents, and U.S. Patent Application Publications cited throughout this specification are hereby incorporated by reference as if fully set forth in this specification.

1. An anion receptor for a non-aqueous electrolyte, comprising:
a compound having the formula 1: 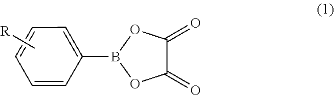
where R is a fluorine bearing moiety.

2. The anion receptor as recited in claim 1, wherein the fluorine bearing moiety is selected from the group consisting of fluorine, fluoromethyl, difluoromethyl, trifluoromethyl, 1-fluoroethyl, 1,1-difluoroethyl, 1,1,2-trifluoroethyl, 1,1,2,2-tetrafluoroethyl and pentafluoroethyl.

3. The anion receptor as recited in claim 1, wherein the anion receptor is selected from the group consisting of pentafluorophenylboron oxalate, 2,4-difluorophenylboron oxalate, 2,5-difluorophenylboron oxalate, 2,3,6-trifluorophenylboron oxalate, and 3,5-bis(trifluoromethyl)phenylboron oxalate.

4. An electrolyte for a lithium ion electrochemical system, comprising:
a lithium based salt, an organic solvent, and an anion receptor, wherein the anion receptor is a compound having the formula 1: 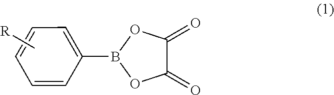
where R is a fluorine bearing moiety.

5. The electrolyte for a lithium ion electrochemical system as recited in claim 4, wherein the fluorine bearing moiety is selected from the group consisting of fluorine, fluoromethyl, difluoromethyl, trifluoromethyl, 1,1-difluoroethyl, 1,1,2-trifluoroethyl, 1,1,2,2-tetrafluoroethyl and pentafluoroethyl.

6. The electrolyte for a lithium ion electrochemical system as recited in claim 5, wherein the anion receptor is selected from the group consisting of pentafluorophenylboron oxalate, 2,4-difluorophenylboron oxalate, 2,5-difluorophenylboron oxalate, 2,3,6-trifluorophenylboron oxalate, and 3,5-bis(trifluoromethyl)phenylboron oxalate.

7. The electrolyte for the lithium ion electrochemical system, as recited in claim 4, wherein the organic solvent selected from ethylene carbonate (EC), propylene carbonate (PC), dimethyl carbonate (DMC), diethyl carbonate (DEC), ethylmethyl carbonate (EMC), γ-butyrolactone (GBL), methyl butyrate (MB), propyl acetate (PA), trimethyl phosphate (TMP), thriphenyl phosphate (TPP), or combinations thereof.

8. The electrolyte for the lithium ion electrochemical system, as recited in claim 7, wherein the solvent is a binary mixed organic solvent containing a 1:1 volume ratio of EC/DMC.

9. The electrolyte for the lithium ion electrochemical system, as recited in claim 7, wherein the solvent is a binary mixed organic solvent containing a 1:1 volume ratio of PC/DMC.

10. The electrolyte for the lithium ion electrochemical system, as recited in claim 4, wherein the lithium based salt is selected from the group consisting of lithium fluoride (LiF), lithium oxide (Li₂O), lithium peroxide (U₂O₂), and a combination thereof.

11. The electrolyte for the lithium ion electrochemical system, as recited in claim 4, wherein the lithium based salt is selected from the group consisting of lithium hexafluorophosphate (LiPF₆), lithium tetrafluoroborate (LiBF₄) and a combination thereof.

12. The electrolyte for the lithium ion electrochemical system, as recited in claim 11, wherein the anion receptor has a molar concentration of 0.05 to 0.5 M.

13. The electrolyte for the lithium ion electrochemical system, as recited in claim 11, wherein the organic solvent comprise a binary mixed organic solvent containing a 1:1 volume ratio of PC/DMC.

14. The electrolyte for the lithium ion electrochemical system, as recited in claim 4, wherein the electrolyte has a molar concentration of 0.3 to 1.0 M.

15. The electrolyte for the lithium ion electrochemical system, as recited in claim 4, wherein the electrolyte is operable to form a stable Solid Electrolyte Interface (SEI) layer on the graphite surface.

16. The electrolyte for the lithium ion electrochemical system, as recited in claim 4, wherein the electrolyte is phosphate free.

17. A lithium ion electrochemical system, comprising:
an anode,
a cathode, and
an electrolyte,
wherein the electrolyte comprises a lithium salt, an organic solvent, and an anion receptor having the formula (1) 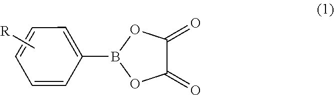
where R is a fluorine bearing moiety.

18. The lithium ion electrochemical system, as recited in claim 17, wherein the anode is a carbon anode.

19. The lithium ion electrochemical system, as recited in claim 18, wherein the carbon anode is a graphite anode.

20. The lithium ion electrochemical system, as recited in claim 17, wherein the cathode is a lithium mixed metal oxide (LiMMO) cathode.

21. The lithium ion electrochemical system, as recited in claim 17, wherein the fluorine bearing moiety is selected from the group consisting of fluorine, fluoromethyl, difluoromethyl, trifluoromethyl, 1,1-difluoro ethyl, 1,1,2-trifluoro ethyl, 1,1,2,2-tetrafluoroethyl and pentafluoroethyl.

22. The lithium ion electrochemical system, as recited in claim 17, wherein the anion receptor is selected from the group consisting of pentafluorophenylboron oxalate, 2,4-difluorophenylboron oxalate, 2,5-difluorophenylboron oxalate, 2,3,6-trifluorophenylboron oxalate, and 3,5-bis(trifluoromethyl)phenylboron oxalate.

23. The lithium ion electrochemical system, as recited in claim 17, wherein the organic solvent is selected from ethylene carbonate (EC), propylene carbonate (PC), dimethyl carbonate (DMC), diethyl carbonate (DEC), ethylmethyl carbonate (EMC), γ-butyrolactone (GBL), methyl butyrate (MB), propyl acetate (PA), trimethyl phosphate (TMP), thriphenyl phosphate (TPP), or combinations thereof.

24. The lithium ion electrochemical system, as recited in claim 23, wherein the organic solvent is a binary mixed organic solvent containing a 1:1 volume ratio of EC/DMC.

25. The lithium ion electrochemical system, as recited in claim 23, wherein the organic solvent is a binary mixed organic solvent containing a 1:1 volume ratio of PC/DMC.

26. The lithium ion electrochemical system, as recited in claim 17, wherein the lithium based salt is selected from the group consisting of lithium fluoride (LiF), lithium oxide (Li₂O), lithium peroxide (Li₂O₂) and a combination thereof.

27. The lithium ion electrochemical system, as recited in claim 17, wherein the lithium based salt is selected from the group consisting of lithium hexafluorophosphate (LiPF₆), lithium tetrafluoroborate (LiBF₄) and a combination thereof.

28. The lithium ion electrochemical system, as recited in claim 27, wherein the anion receptor has a molar concentration of 0.05 to 1 M.

29. The lithium ion electrochemical system, as recited in claim 28, wherein the organic solvent is a binary mixed organic solvent containing a 1:1 volume ratio of PC/DMC.

30. The lithium ion electrochemical system, as recited in claim 17, wherein the electrolyte has a molar concentration of 0.3 to 1.0 M.

31. The lithium ion electrochemical system, as recited in claim 19, wherein the electrolyte is operable to form a stable Solid Electrolyte Interface (SEI) layer on the graphite surface.

32. The lithium ion electrochemical system, as recited in claim 19, wherein an active material of the graphite anode is mesophase carbon microbeads (MCMB).

33. A rechargeable lithium ion battery cell, comprising: an anode; a cathode, and the electrolyte of claim 4.

34. A lithium ion electrochemical system, comprising:
a graphite anode,
a lithium mixed metal oxide (LiMMO) cathode,
an electrolyte, wherein the electrolyte comprises a lithium based salt, an anion receptor, and a
solvent;
wherein the lithium based salt is selected from the group consisting of LiF, Li₂O, Li₂O₂ and a mixture thereof, the anion receptor is selected from the group consisting of pentafluorophenylboron oxalate, 2,4-difluorophenylboron oxalate, 2,5-difluorophenylboron oxalate, 2,3,6-trifluorophenylboron oxalate, and 3,5-bis(trifluoromethyl)phenylboron oxalate, and the organic solvent is a binary mixed organic solvent at the molar concentration of 0.3 to 1.0 M containing a 1:1 volume ratio of EC/DMC or PC/DMC; and
wherein the electrolyte is able to form a stable Solid Electrolyte Interface (SEI) layer on the graphite surface of the graphite anode.

35. The lithium ion electrochemical system, as recited in claim 34, wherein the anion receptor is pentafluorophenylboron oxalate.

36. The lithium ion electrochemical system, as recited in claim 34, wherein the electrochemical system is a rechargeable lithium ion battery cell.

37. A lithium ion electrochemical system, comprising:
a graphite anode,
a lithium mixed metal oxide (LiMMO) cathode,
an electrolytes, wherein the electrolyte comprises a lithium based salt, an organic solvent, and
an anion receptor as an additive;
wherein the lithium based salt is selected from the group consisting of lithium hexafluorophosphate (LiPF₆), lithium tetrafluoroborate (LiBF₄) and a combination thereof;
the anion receptor is selected from the group consisting of pentafluorophenylboron oxalate, 2,4-difluorophenylboron oxalate, 2,5-difluorophenylboron oxalate, 2,3,6-trifluorophenylboron oxalate, 3,5-bis(trifluoromethyl)phenylboron oxalate, and a combination thereof at a molar concentration of 0.05 M to 0.5M, and the organic solvent is a binary mixed organic solvent at the molar concentration of 0.3 to 1.0 M containing a 1:1 volume ratio of PC/DMC; and
wherein the electrolyte is operable to form a stable Solid Electrolyte Interface (SEI) layer on the graphite surface of the graphite anode.

38. The lithium ion electrochemical system, as recited in claim 37, wherein the anion receptor is pentafluorophenylboron oxalate.

39. The lithium ion electrochemical system, as recited in claim 37, wherein the electrochemical system is a rechargeable lithium ion battery cell.

40. A method of forming a stable Solid Electrolyte Interface (SEI) layer on a graphite surface of a graphite anode in a lithium ion electrochemical system comprising adding to an electrolyte a sufficient amount of an anion receptor having the general formula (1) 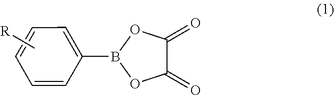
where R is a fluorine bearing moiety.

41. The method of claim 40, wherein the anion receptor is selected from the group consisting of pentafluorophenylboron oxalate, 2,4-difluorophenylboron oxalate, 2,5-difluorophenylboron oxalate, 2,3,6-trifluorophenylboron oxalate, and 3,5-bis(trifluoromethyl)phenylboron oxalate.
